(19) United States
(12) Patent Application Publication
(10) Pub. No.: US 2019/0116409 A1
(43) Pub. Date: Apr. 18, 2019

(54) COVERT BLUETOOTH HEADSET

(71) Applicant: Giles Meredith Jones, New York, NY (US)

(72) Inventor: Giles Meredith Jones, New York, NY (US)

(21) Appl. No.: 16/162,924

(22) Filed: Oct. 17, 2018

Related U.S. Application Data
(60) Provisional application No. 62/573,361, filed on Oct. 17, 2017.

(51) Int. Cl. H04R 1/10; H04R 1/02; H04R 5/033

(52) U.S. Cl. CPC H04R 1/105; H04R 1/028; H04R 2420/07; H04R 1/1016; H04R 2201/023; H04R 5/0335

(57) ABSTRACT

An audio device securing apparatus includes a button-pin stay including a pin coupled thereto. The pin projects outwards away from the button-pin stay. The pin includes a pointed end facing away from the button-pin stay. The pointed end of the pin is configured to pierce a shirt collar, tie or jacket. A magnet faces away from the button-pin stay. The magnet is dimensioned and positioned to hold an ear bud including a metal component under the shirt collar. A pin stop is coupled to the magnet. The pin stop is dimensioned and positioned to house the pointed end of the pin.

### CROSS-REFERENCE TO RELATED APPLICATION

This U.S. Non-Provisional Patent Application claims priority to U.S. Provisional Patent Application No. 62/573,361, filed on Oct. 17, 2017, the disclosure of which is incorporated by reference herein in its entirety.

### TECHNICAL FIELD

Exemplary embodiments of the present invention relate to headphones included in a headset, and more particularly to a covert Bluetooth headset, which is secured and hidden under a shirt collar, behind a neck-tie or on a jacket.

### BACKGROUND

Currently, there are portable Bluetooth headsets on the market which are worn about a user's body in clear view, which may limit the appeal of wearing the headset for day-long use. Many users would prefer the accessibility of a headset that is covert and hidden from clear view.

### SUMMARY

Exemplary embodiments of the present invention include an audio device securing apparatus includes a button-pin stay including a pin coupled thereto. The pin projects outwards away from the button-pin stay. The pin includes a pointed end facing away from the button-pin stay. The pointed end of the pin is configured to pierce a shirt collar, tie or jacket. A magnet faces away from the button-pin stay. The magnet is dimensioned and positioned to hold an ear bud including a metal component under the shirt collar. A pin stop (also known as pin-cap) is coupled to the magnet. The pin stop is dimensioned and positioned to house the pointed end of the pin.

According to an exemplary embodiment of the present invention, the magnet may have a circular shape.

According to an exemplary embodiment of the present invention, the magnet may have a donut shape. The pin stop may be disposed in a center of the donut shaped magnet.

According to an exemplary embodiment of the present invention, at least a portion of the pin stop may have a greater thickness than a thickness of the donut shaped magnet.

According to an exemplary embodiment of the present invention, the magnet may be a neodymium magnet.

According to an exemplary embodiment of the present invention, the pin stop may include Polyvinyl chloride (PVC) or silicone, to secure the pin.

According to an exemplary embodiment of the present invention, the magnet may have a dome shape. The pin stop may be disposed on a concave side of the dome shaped magnet.

According to an exemplary embodiment of the present invention, a wireless audio device includes a button-pin stay including a pin coupled thereto. The pin projects away from the button-pin stay. The pin includes a pointed end facing away from the button-pin stay. The pointed end of the pin is configured to pierce a shirt collar. A magnet faces away from the button-pin stay. The magnet is dimensioned and positioned to hold an ear bud under the shirt collar. A pin stop is coupled to the magnet. The pin stop is dimensioned and positioned to house the pointed end of the pin. The ear bud includes a metal component dimensioned and positioned to be coupled with the magnet.

According to an exemplary embodiment of the present invention, the metal component may have substantially a same shape as the magnet.

According to an exemplary embodiment of the present invention, the magnet may be a neodymium magnet.

According to an exemplary embodiment of the present invention, each of the magnet and the metal component may have a circular shape.

According to an exemplary embodiment of the present invention, each of the magnet and the metal component may have a donut shape. The pin stop may be disposed in a center of the donut shaped magnet.

According to an exemplary embodiment of the present invention, at least a portion of the pin stop may have a greater thickness than a thickness of the donut shaped magnet.

According to an exemplary embodiment of the present invention, the ear bud may be configured to communicate with an autonomous device through a Bluetooth connection.

According to an exemplary embodiment of the present invention, the magnet may have a dome shape. The pin stop may be disposed on a concave side of the dome shaped magnet.

### BRIEF DESCRIPTION OF THE DRAWINGS

The above and other features of the present invention will become more apparent by describing in detail exemplary embodiments thereof, with reference to the accompanying drawings in which:

FIG. 1 illustrates a side view of a button-pin stay, a pin stop including a magnet and an ear bud including a metal component disconnected from each other according to an exemplary embodiment of the present invention.

FIG. 2 illustrates an inside shirt collar view of a button-pin stay according to an exemplary embodiment of the present invention.

FIG. 3 illustrates an unfolded shirt collar including a button-pin stay on an inside of the shirt and a pin stop on an outside of the shirt under the unfolded shirt collar according to an exemplary embodiment of the present invention.

FIG. 4 illustrates an unfolded shirt collar including a button-pin stay on an inside of the shirt and a pin stop with an ear bud magnetically attached thereto on an outside of the shirt under the unfolded shirt collar according to an exemplary embodiment of the present invention.

FIG. 5 illustrates first and second ear buds magnetically attached to corresponding magnets coupled to corresponding pin stops according to an exemplary embodiment of the present invention.

FIG. 6 illustrates first and second ear buds magnetically attached to corresponding magnets coupled to corresponding pin stops, and a button-pin stay on an inside of a shirt according to an exemplary embodiment of the present invention.

FIG. 7 illustrates first and second ear buds magnetically attached to corresponding magnets coupled to corresponding pin stops under a folded shirt collar according to an exemplary embodiment of the present invention.

FIG. 8 illustrates a folded shirt collar with concealed ear buds thereunder according to an exemplary embodiment of the present invention.

FIG. 9 illustrates a button-pin stay with a pin projecting entirely through a folded shirt collar and an ear bud magnetically coupled to a magnet disposed on a pin stop positioned on an outside of a folded shirt collar according to an exemplary embodiment of the present invention.

FIG. 10 illustrates a dome shaped pin stop and a corresponding pin according to an exemplary embodiment of the present invention.

FIG. 11 illustrates a dome shaped pin stop inside a dome shaped magnet and a corresponding pin according to an exemplary embodiment of the present invention.

FIGS. 12 and 13 illustrate an audio device securing apparatus coupled to a jacket according to an exemplary embodiment of the present invention.

FIG. 14 illustrates an audio device securing apparatus including a magnet secured to a shirt stud according to an exemplary embodiment of the present invention.

FIG. 15 illustrates an audio device securing apparatus according to an exemplary embodiment of the present invention.

FIG. 16 illustrates an audio device securing apparatus according to an exemplary embodiment of the present invention.

### DETAILED DESCRIPTION

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

Exemplary embodiments of the present invention will be described more fully hereinafter with reference to the accompanying drawings. Like reference numerals may refer to like elements throughout the specification and drawings.

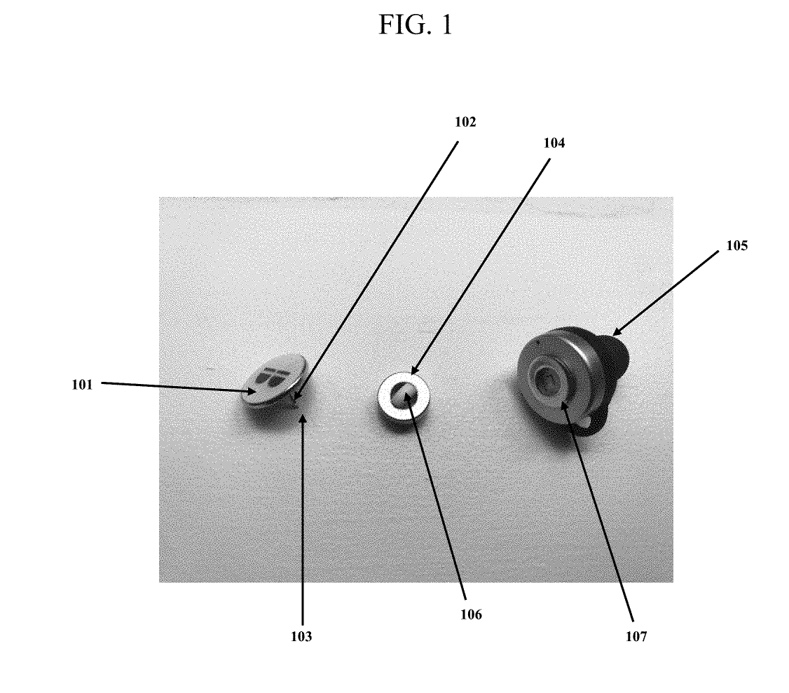

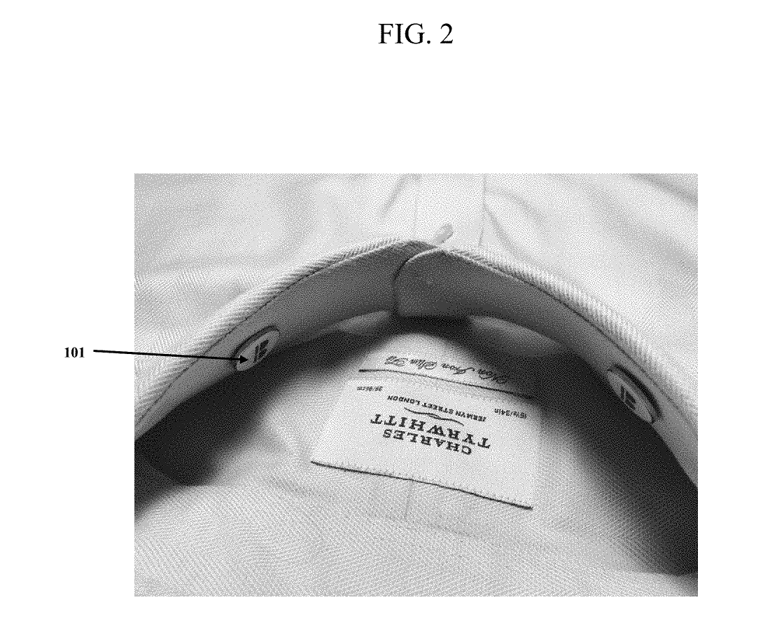

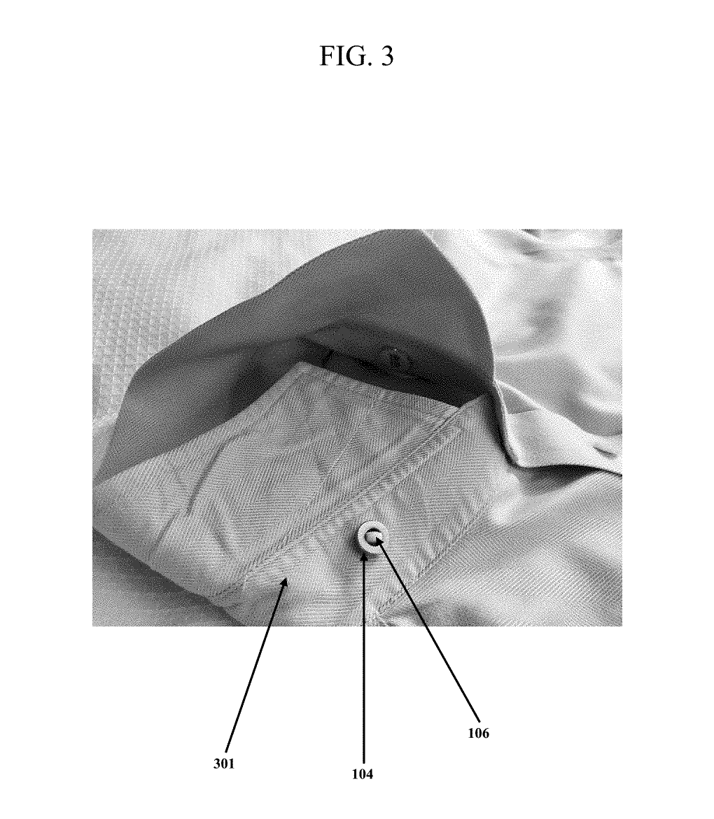

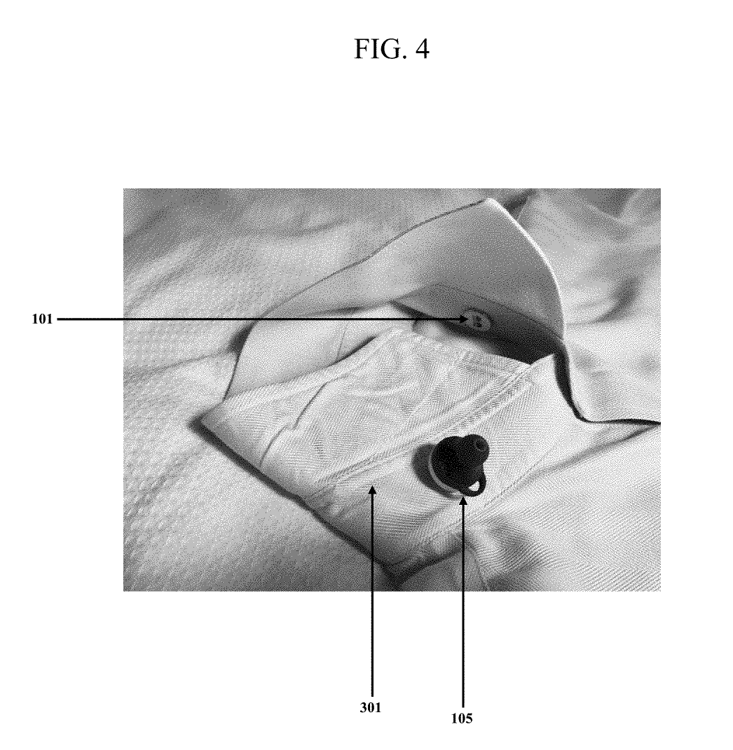

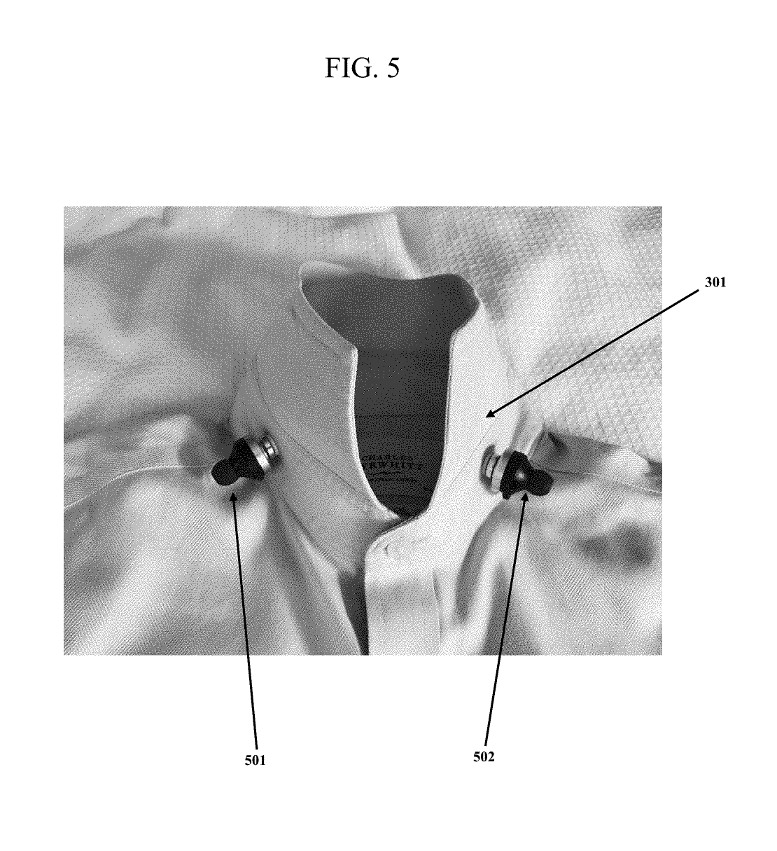

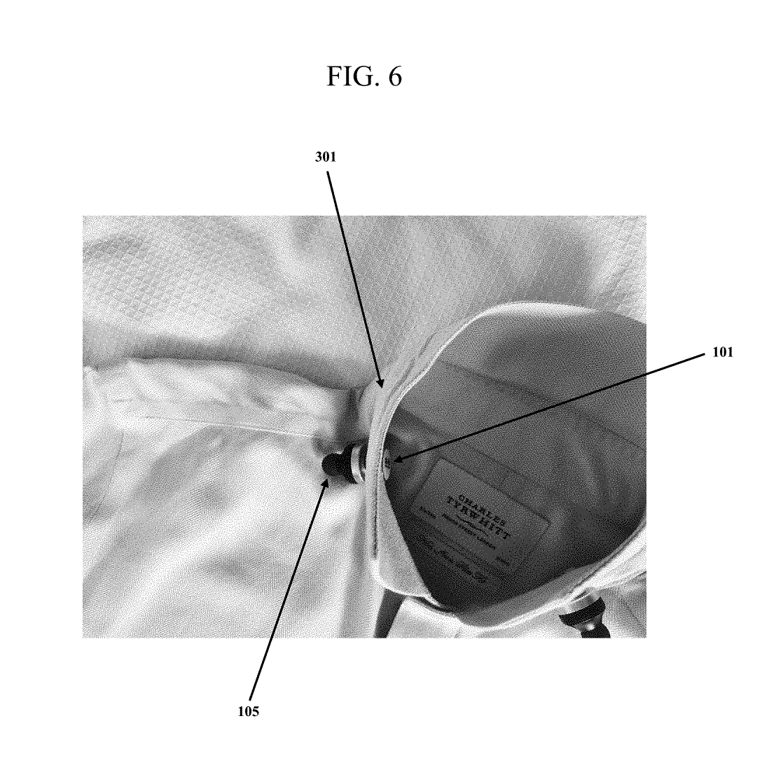

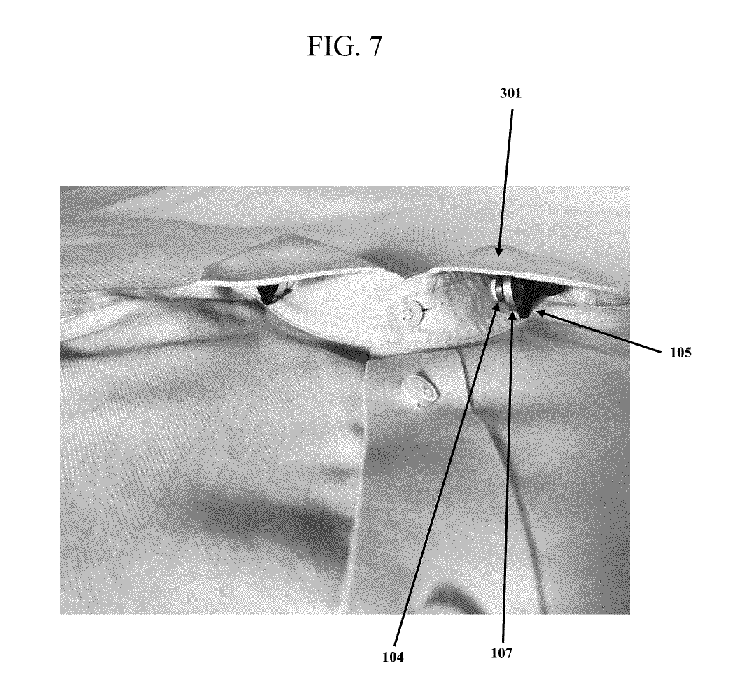

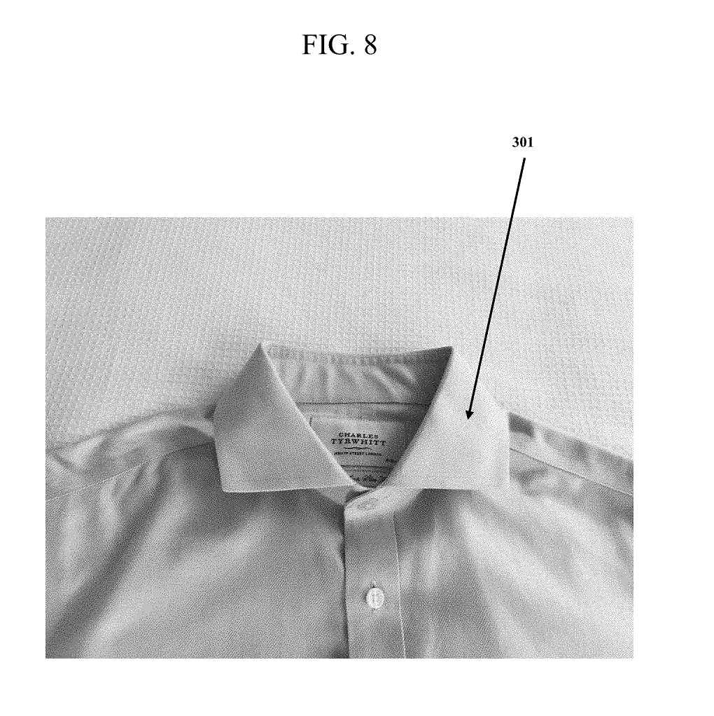

FIG. 1 illustrates a side view of a button-pin stay, a pin stop including a magnet and an ear bud including a metal component disconnected from each other according to an exemplary embodiment of the present invention. FIG. 2 illustrates an inside shirt collar view of a button-pin stay according to an exemplary embodiment of the present invention. FIG. 3 illustrates an unfolded shirt collar including a button-pin stay on an inside of the shirt and a pin stop on an outside of the shirt under the unfolded shirt collar according to an exemplary embodiment of the present invention. FIG. 4 illustrates an unfolded shirt collar including a button-pin stay on an inside of the shirt and a pin stop with an ear bud magnetically attached thereto on an outside of the shirt under the unfolded shirt collar according to an exemplary embodiment of the present invention. FIG. 5 illustrates first and second ear buds magnetically attached to corresponding magnets coupled to corresponding pin stops according to an exemplary embodiment of the present invention. FIG. 6 illustrates first and second ear buds magnetically attached to corresponding magnets coupled to corresponding pin stops, and a button-pin stay on an inside of a shirt according to an exemplary embodiment of the present invention. FIG. 7 illustrates first and second ear buds magnetically attached to corresponding magnets coupled to corresponding pin stops under a folded shirt collar according to an exemplary embodiment of the present invention. FIG. 8 illustrates a folded shirt collar with concealed ear buds thereunder according to an exemplary embodiment of the present invention.

The audio securing apparatus and/or the wireless audio device described herein may be hidden about a user's body. For example, the audio securing apparatus and/or the wireless audio device may be hidden out of view under a user's shirt collar. Alternatively, the audio securing apparatus and/or the wireless audio device may be hidden inside a user's shirt pocket or elsewhere within a user's clothing. This provides a headset, such as a Bluetooth headset or Bluetooth earbuds that are hidden from plain view about a user's body. This may prevent theft of the Bluetooth headset or earbuds, may protect the Bluetooth headset or earbuds from damage and may be prevent accidental loss of the Bluetooth headset or earbuds.

Referring to FIGS. 1-8, according to an exemplary embodiment of the present invention, an audio device securing apparatus includes button-pin stay 101 including a pin 102 coupled thereto. The pin 102 projects away from the button-pin stay 101. The pin 102 includes a pointed end 103 facing away from the button-pin stay 101. The pointed end 103 of the pin 102 is configured to pierce a shirt collar 301. A magnet (e.g., magnet 104) faces away from the button-pin stay 101. The magnet 104 is dimensioned and positioned to hold an ear bud 501 including a metal component (e.g., metal component 107) under the shirt collar 301. A pin stop is coupled to the magnet 104. The pin stop 106 is dimensioned and positioned to house the pointed end 103 of the pin 102.

Some of the figures and descriptions provided herein might only illustrate a single audio device securing apparatus. However, it will be understood to a person of ordinary skill in the art that two audio securing device apparatuses may be provided for use on both right and left sides of a user's body (e.g., a first ear bud 501 and a second ear bud 502—see, e.g., FIG. 5). For example, a set of two Bluetooth audio devices may be coupled to a user's shirt collar, as described herein. The two Bluetooth audio devices may be substantially identical to each other, or may predetermined right and left orientations. For example, only a left Bluetooth audio device might be equipped with a microphone and/or an LED indicator light, while a right Bluetooth audio device may omit features such as the microphone (e.g., to conserve battery power). The Bluetooth audio devices may be rechargeable devices configured to be recharged using any desired portable or non-portable charging apparatuses.

According to an exemplary embodiment of the present invention, the magnet 104 may have a circular shape (see, e.g., FIG. 1). However, exemplary embodiments of the present invention are not limited thereto. For example, the magnet may be a circular disc, may include a hole therein for housing the pin 102 and/or may have dome shape, as described in more detail below.

According to an exemplary embodiment of the present invention, the magnet 104 may have a donut shape. The pin stop 106 may be disposed in a center of the donut shaped magnet. Thus, the pin 102 may pass through a donut hole and may be secured in the pin stop 106 to prevent a user from coming into contact with the pointed end 103 of the pin 102.

According to an exemplary embodiment of the present invention, at least a portion of the pin stop 106 may have a greater thickness than a thickness of the donut shaped magnet 104 along an extending direction of the pin 102. This may allow sufficient space within the pin stop 106 to house the pin 102.

According to an exemplary embodiment of the present invention, the magnet 104 may be a neodymium magnet. Neodymium magnets are relatively strong magnets that provide the desired combination of size and strength to covertly hold a portable audio device under a user's shirt collar without the portable audio device being lost as a result of routine movement about a user's environment. Thus, the ear buds described herein may be securely, but removably coupled under a user's shirt collar (e.g., in a concealed position under the user's shirt collar) or concealed on the inside pocket of a jacket.

According to an exemplary embodiment of the present invention, the pin stop 106 may include Polyvinyl chloride (PVC). However, exemplary embodiments of the present invention are not limited thereto, and other materials may be employed, as desired.

According to an exemplary embodiment of the present invention, the button-pin stay 101 may include a heart rate sensor coupled thereto. Thus, a user's heart rate may be detected and sent to a connected Bluetooth device such as a Smartphone positioned about the user's body or within relatively close proximity to the user.

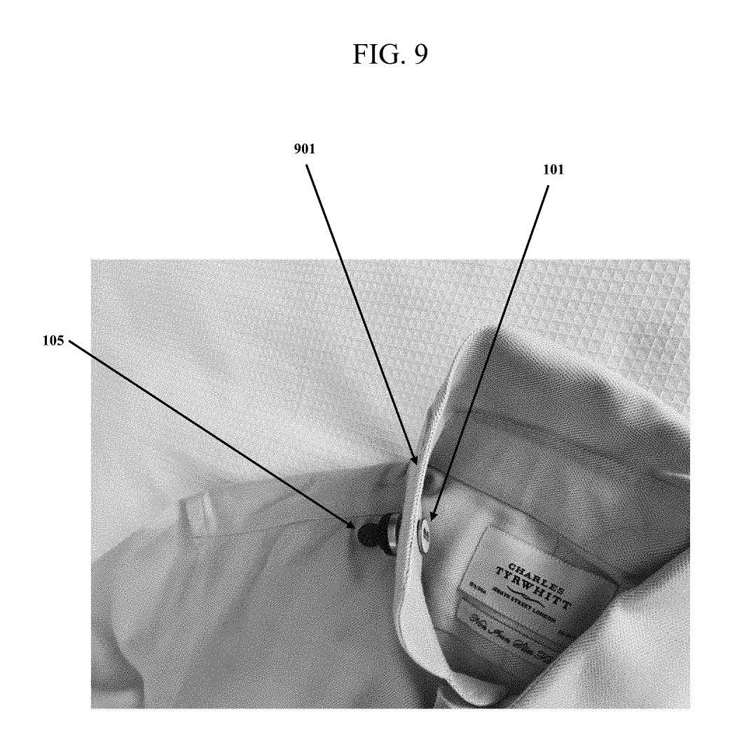

FIG. 9 illustrates a button-pin stay with a pin projecting entirely through a folded shirt collar and an ear bud magnetically coupled to a magnet disposed on a pin stop positioned on an outside of a folded shirt collar according to an exemplary embodiment of the present invention.

According to an exemplary embodiment of the present invention, the pin 102 of the audio device securing apparatus may project entirely though a folded shirt collar 901. Thus, the first and/or second ear buds 501 and/or 502 may be positioned outside a folded shirt collar.

According to an exemplary embodiment of the present invention, a wireless audio device includes a button-pin stay 101 including a pin 102 coupled thereto. The pin 102 projects away from the button-pin stay 101. The pin 102 includes a pointed end 103 facing away from the button-pin stay 101. The pointed end 103 of the pin 102 is configured to pierce a shirt collar 301. A magnet 104 faces away from the button-pin stay 101. The magnet 104 is dimensioned and positioned to hold an ear bud 105 under the shirt collar 301. A pin stop 106 is coupled to the magnet 104. The pin stop 106 is dimensioned and positioned to house the pointed end 103 of the pin 102. The ear bud 105 includes a metal component 107 dimensioned and positioned to be coupled with the magnet 104.

According to an exemplary embodiment of the present invention, the metal component 107 may have substantially a same shape as the magnet 104. For example, each of the magnet and the metal component 104 and 107 may be donut shaped, and may have substantially a same size as each either (e.g., to maximize surface area between the magnets). Alternatively, the magnet and the metal component 104 and 107 may have different shapes from each other (e.g., circular or donut and dome shapes, respectively).

According to an exemplary embodiment of the present invention, the magnet 104 may be a neodymium magnet, as described in more detail above.

According to an exemplary embodiment of the present invention, each of the magnet and the metal component 104 and 107 may have a circular shape.

According to an exemplary embodiment of the present invention, each of the magnet and the metal component 104 and 107 may have a donut shape. The pin stop 106 may be disposed in a center of the donut shaped magnet 104.

According to an exemplary embodiment of the present invention, at least a portion of the pin stop 106 may have a greater thickness than a thickness of the donut shaped magnet 104 (e.g., along an extending direction of the pin 102).

According to an exemplary embodiment of the present invention, the ear bud 105 may be configured to communicate with an autonomous device (e.g., a Smartphone) through a Bluetooth connection. As an example, the ear bud 105 may operate at a frequency of 2400.0-2483.5 MHz, at an operating range of 10 meters.

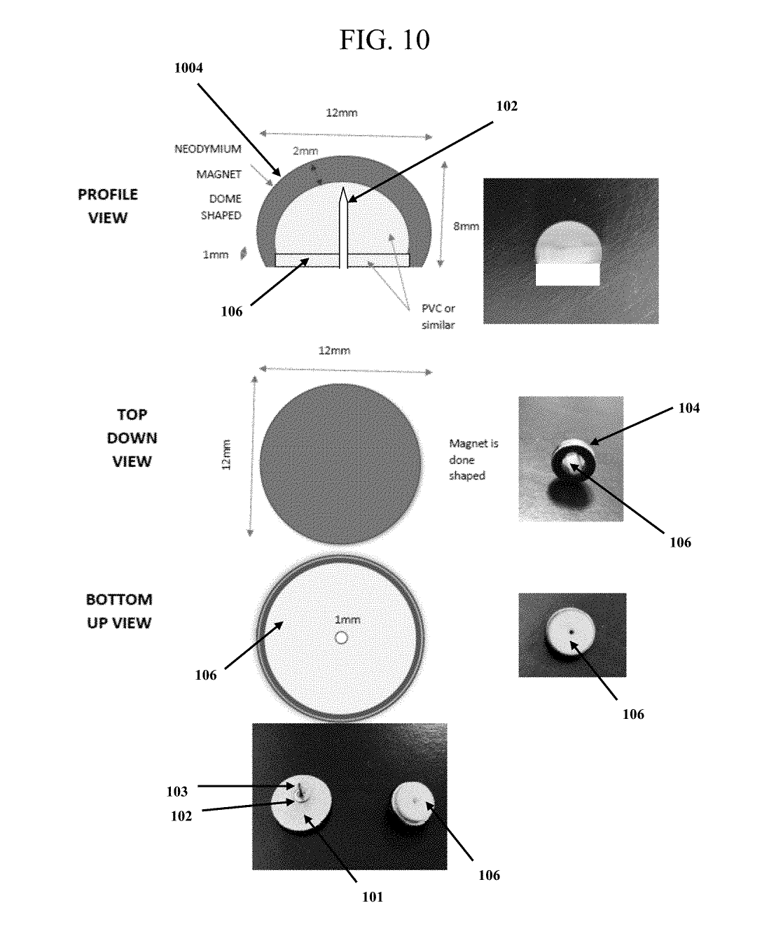

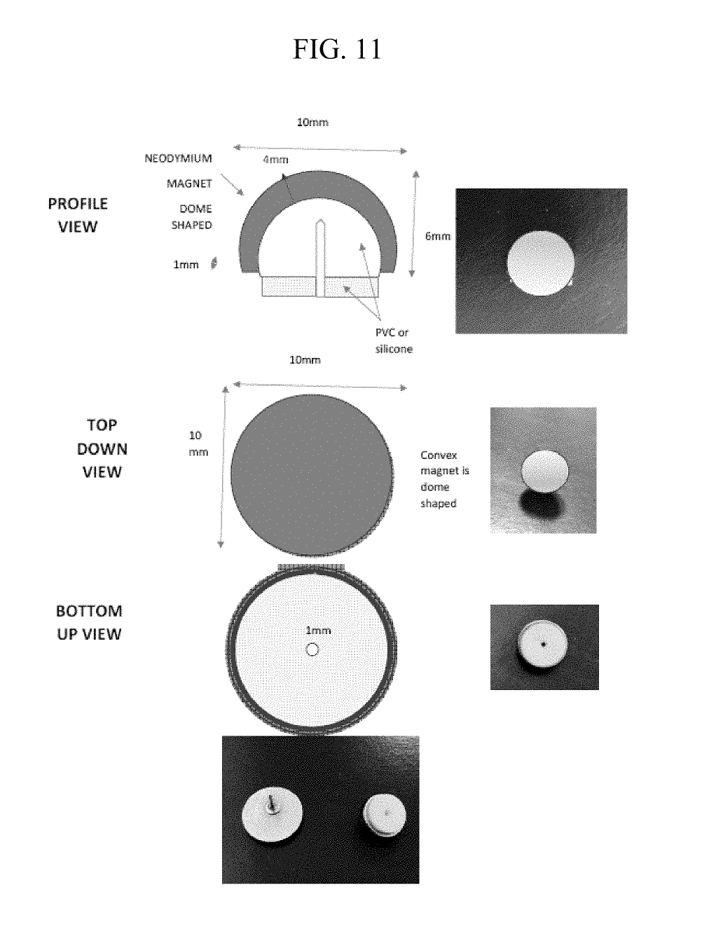

FIG. 10 illustrates a dome shaped pin stop and a corresponding pin according to an exemplary embodiment of the present invention. FIG. 11 illustrates a dome shaped pin stop inside a dome shaped magnet and a corresponding pin according to an exemplary embodiment of the present invention.

Referring to FIGS. 10 and 11, according to an exemplary embodiment of the present invention, a magnet 1004 may have a dome shape. The magnet 1004 is substantially the same as the magnet 104 described in more detail above, except for the dome shape of the magnet. The pin stop 106 may be disposed on a concave side of the dome shaped magnet 1004, and thus increased freedom of motion may be achieved. Thus, the pin stop 106 may be disposed on a concave side of the dome shaped magnet 1004.

According to an exemplary embodiment of the present invention, the magnet 104 may have a dome shape. The pin stop 106 may be disposed on a concave side of the dome shaped magnet 104 (see, e.g., FIG. 11 illustrating the pin stop 106 positioned inside the dome shaped magnet). For example, in the top down view of FIG. 10 the pin stop 106 is shown; however, the pin stop 106 would actually be inside the dome shaped magnet (see, e.g., FIG. 11).

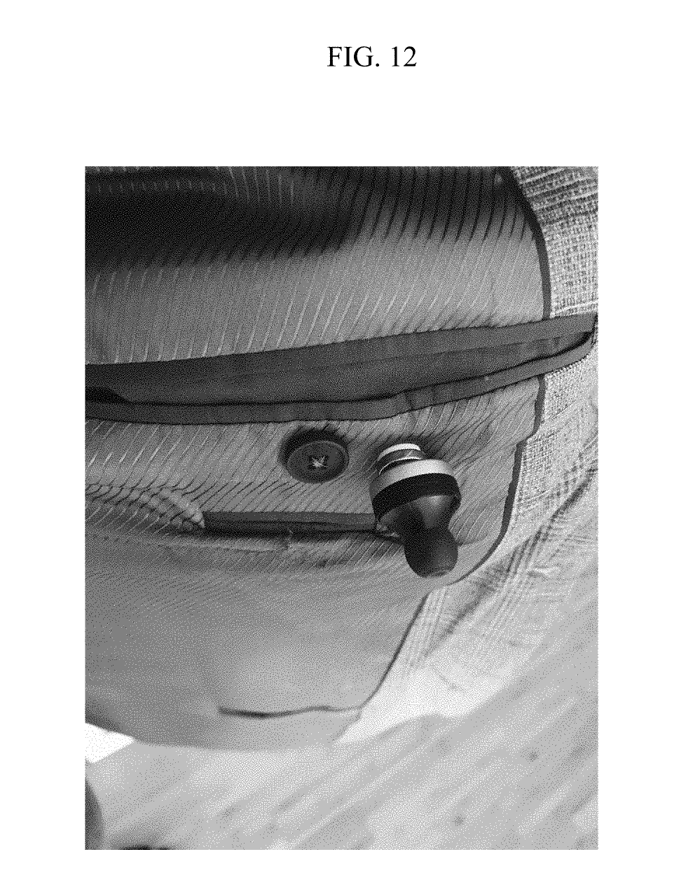

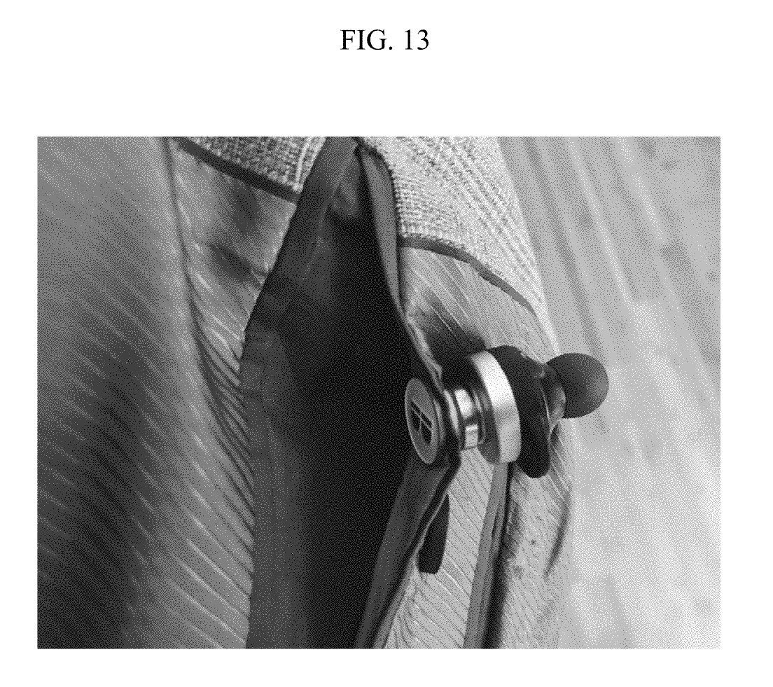

FIGS. 12 and 13 illustrate an audio device securing apparatus coupled to a jacket according to an exemplary embodiment of the present invention.

Referring to FIGS. 12 and 13, the audio device securing apparatus according to an exemplary embodiment of the present invention may be coupled to a user's jacket. For example, the audio device securing apparatus may be coupled to a jacket pocket, as illustrated, for example, in FIGS. 12 and 13.

According to exemplary embodiments of the present invention, the Bluetooth headset may be hidden and secured under an existing wearer's shirt collar to provide all-day ease of access and comfort for phone call or music listening.

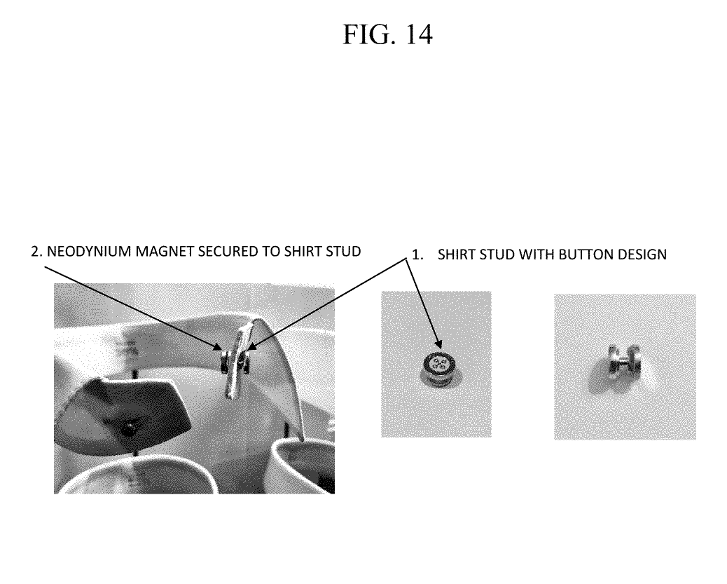

FIG. 14 illustrates an audio device securing apparatus including a magnet secured to a shirt stud according to an exemplary embodiment of the present invention.

Referring to FIG. 14, according to an exemplary embodiment of the present invention, a magnet (e.g., a neodymium magnet, as described herein) may be secured to a shirt stud. The shirt stud may have a button shape. For example. The shirt stud and associated magnet may each have flat surfaces, and a pin connecting between the flat surfaces through a shirt worn by a user. For example, the shirt stud and associated magnet may include a substantially flat surface facing a user and a substantially flat surface facing away from the user (e.g., toward an underside of a collar associated with the shirt). Thus, the magnet may be positioned under the shirt collar and may be secured in position by the shirt stud. As an example, the shirt stud may pass through a button hole associated with a shirt collar. Thus, an existing button hole on the shirt may be used to secure the magnet in a desired position.

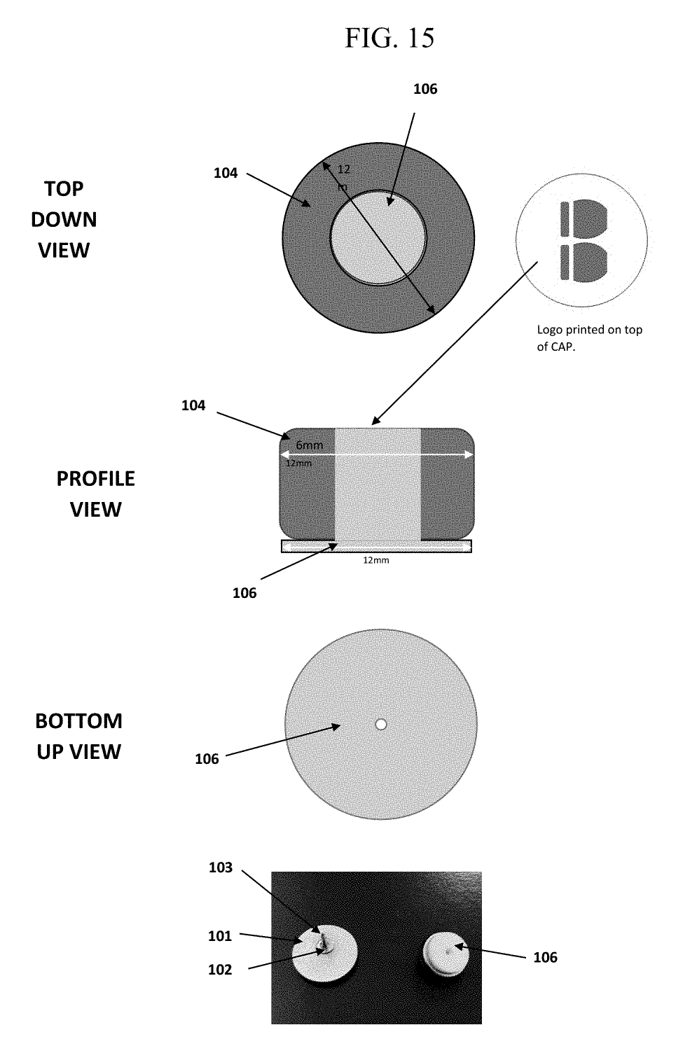

FIG. 15 illustrates an audio device securing apparatus according to an exemplary embodiment of the present invention.

Referring to FIG. 15, a magnet (e.g., magnet 104) may be positioned opposite the pin stop 106. The magnet (e.g., magnet 104) faces away from the button-pin stay 101. The pin stop 106 may be dimensioned and positioned to house the pointed end 103 of the pin 102. A logo may be printed on a surface of the magnet 104 and/or the pin stop 106.

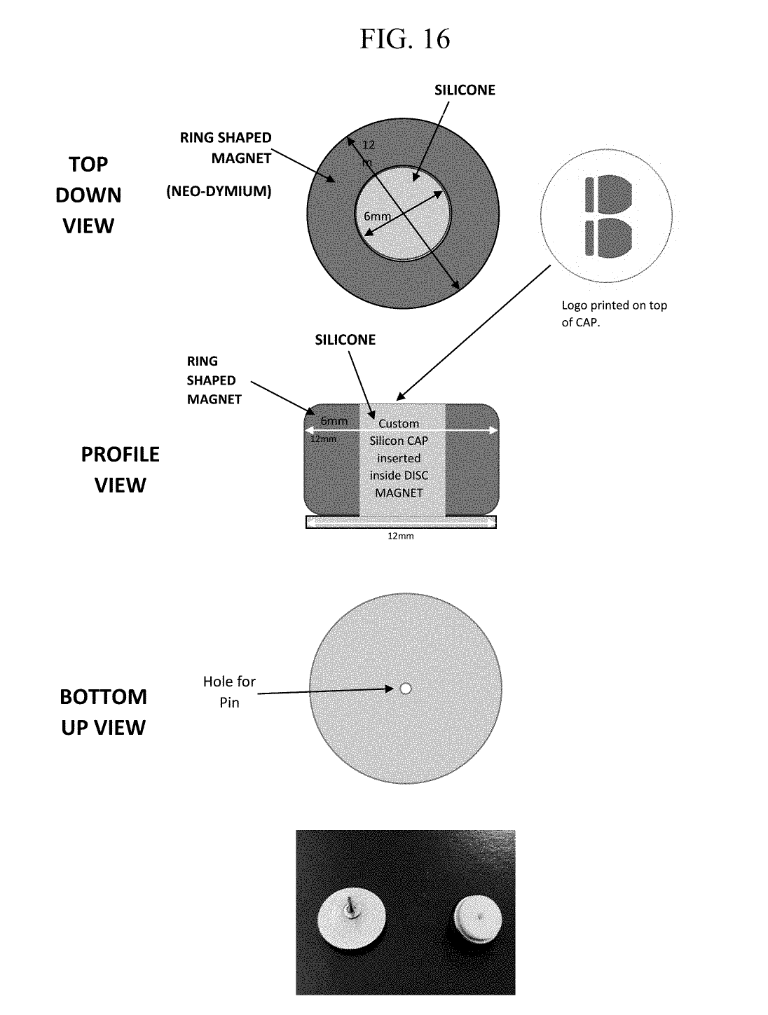

FIG. 16 illustrates an audio device securing apparatus according to an exemplary embodiment of the present invention.

Referring to FIG. 16, a magnet (e.g., magnet 104) may be positioned opposite the pin stop 106. The magnet (e.g., magnet 104) faces away from the button-pin stay 101. The pin stop 106 may be dimensioned and positioned to house the pointed end 103 of the pin 102. A logo may be printed on a surface of the magnet 104 and/or the pin stop 106. The magnet may be a disk magnet, and a silicon cap may be inserted inside the disc magnet.

Having described exemplary embodiments of the present invention, it is further noted that it is readily apparent to those of ordinary skill in the art that various modifications may be made without departing from the spirit and scope of the present invention.

What is claimed is:

1. Audio device securing apparatus, comprising:
a button-pin stay comprising a pin coupled thereto, wherein the pin projects away from the button-pin stay, wherein the pin comprises a pointed end facing away from the button-pin stay, and wherein the pointed end of the pin is configured to pierce a shirt collar;
a magnet facing away from the button-pin stay, wherein the magnet is dimensioned and positioned to hold an ear bud comprising a metal component under the shirt collar; and
a pin stop coupled to the magnet, wherein the pin stop is dimensioned and positioned to house the pointed end of the pin.

2. The audio device securing apparatus of claim 1, wherein the magnet has a circular or ring shape.

3. The audio device securing apparatus of claim 2, wherein the magnet has a donut shape, and wherein the pin stop is disposed in a center of the donut shaped magnet.

4. The audio device securing apparatus of claim 3, wherein at least a portion of the pin stop has a greater thickness than a thickness of the donut shaped magnet

5. The audio device securing apparatus of claim 4, wherein the magnet is a neodymium magnet.

6. The audio device securing apparatus of claim 5, wherein the pin stop comprises Polyvinyl chloride (PVC) or Silicone.

7. The audio device securing apparatus of claim 2, wherein the magnet has a dome shape, and wherein the pin stop is disposed on a concave side of the dome shaped magnet.

8. The audio device securing apparatus of claim 7, wherein the magnet is a neodymium magnet.

9. The audio device securing apparatus of claim 8, wherein the pin stop comprises Polyvinyl chloride (PVC) or Silicone.

10. Wireless audio device, comprising:
a button-pin stay comprising a pin coupled thereto, wherein the pin projects away from the button-pin stay, wherein the pin comprises a pointed end facing away from the button-pin stay, and wherein the pointed end of the pin is configured to pierce a shirt collar or clothing;
a magnet facing away from the button-pin stay, wherein the magnet is dimensioned and positioned to hold an ear bud under the shirt collar; and
a pin stop coupled to the magnet, wherein the pin stop is dimensioned and positioned to house the pointed end of the pin,
wherein the ear bud comprises a metal component dimensioned and positioned to be coupled with the first magnet.

11. The wireless audio device of claim 10, wherein the metal component has substantially a same shape as the magnet.

12. The wireless audio device of claim 11, wherein each of the magnet is a neodymium magnet.

13. The audio device securing apparatus of claim 12, wherein the magnet and the metal component each have a circular or ring shape.

14. The audio device securing apparatus of claim 12, wherein the magnet and the metal component each have a circular or ring shape, and wherein the pin stop is disposed in a center of the circular or ring shaped magnet.

15. The audio device securing apparatus of claim 13, wherein at least a portion of the pin stop has a greater thickness than a thickness of the circular or ring shaped magnet

16. The audio device securing apparatus of claim 14, wherein the pin stop comprises Polyvinyl chloride (PVC) or Silicone.

17. The audio device securing apparatus of claim 16, wherein the ear bud is configured to communicate with an autonomous device through a Bluetooth connection.

18. The audio device securing apparatus of claim 10, wherein the magnet has a dome shape, and wherein the pin stop is disposed on a concave side of the dome shaped magnet.

19. The audio device securing apparatus of claim 18, wherein the magnet is a neodymium magnet.

20. The audio device securing apparatus of claim 19, wherein the ear bud is configured to communicate with an autonomous device through a Bluetooth connection.
